(19) United States
(12) Patent Application Publication
(10) Pub. No.: US 2009/0174301 A1
(43) Pub. Date: Jul. 9, 2009

(54) Radiation-emitting device comprising a plurality of radiation-emitting components and illumination device

(76) Inventors: Peter Frey, Heidenheim (DE); Peter Helbig, Sontheim/Brenz (DE); Thomas Kipke, Laichingen (DE); Christine Maier, Asselfingen (DE); Thomas Reiners, Bachhagel (DE); Thomas Rieger, Herbrechtingen (DE); Ralf Vollmer, Ulm (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/309,152

(22) PCT Filed: Jul. 13, 2007
(86) PCT No.: PCT/EP2007/057229

§ 371 Date: Jan. 8, 2009

(30) Foreign Application Priority Data
Jul. 21, 2006 (DE) 10 2006 033 873.1

(51) Int. Cl. H01J 7/44; H01J 9/00

(52) U.S. Cl. 313/1; 445/23

(57) ABSTRACT

A method for producing a radiation-emitting device comprising a plurality of radiation-emitting components (3) may comprise in particular the following steps: A) providing a carrier body (1) with a surface (10) having different partial surface regions (11, 12), wherein the normal vectors (110, 120) of the different partial surface regions (11, 12) point in different spatial directions, B) arranging at least two radiation-emitting components (3) on two different partial surface regions (11, 12), and C) producing electrical contact-connections to the radiation-emitting components (3).

The present invention relates to a method for producing a radiation-emitting device comprising at least two radiation-emitting components according to the preamble of claim 1, and to a method for producing an illumination device according to the preamble of claim 40. Furthermore, the invention relates to a radiation-emitting device comprising at least two radiation-emitting components according to the preamble of claim 41 and an illumination device according to the preamble of claim 42.

The document EP 1 371 901 A2 describes lamps having supports with a plurality of planar side faces on which LEDs are fitted. However, EP 1 371 901 A2 does not disclose how the LEDs can be electrically contact-connected.

The documents U.S. Pat. No. 6,465,961 B1 and U.S. Pat. No. 6,746,885 B2 describe light sources having heat sinks with a plurality of planar faces on which light emitting semiconductor chips are fitted.

The document DE 103 33 837 A1 specifies a light emitting diode module in which a plurality of light emitting diodes are arranged along a curved line on a surface region. By contrast, the document DE 103 33 836 A1 describes a light emitting diode module comprising an arrangement of a plurality of light emitting diodes and a light directing means on an axially symmetrical

carrier. In this case, neither of the two documents discloses an electrical contact-connection of the light emitting diodes.

It is an object of the present invention to specify a method for producing a radiation-emitting device comprising at least two radiation-emitting components. It is furthermore an object of the present invention to specify a method for producing an illumination device comprising a radiation-emitting device, and also such an illumination device.

These objects are achieved by means of the features of the independent patent claims. Advantageous embodiments and developments of the methods and also advantageous embodiments and developments of the radiation-emitting device and also of the illumination device emerge from the dependent patent claims and the description below and also the drawings.

A method for producing a radiation-emitting device can comprise in particular the steps of:

A) providing a carrier body with a surface having different partial surface regions, wherein the normal vectors of the different partial surface regions point in different spatial directions,
B) arranging at least two radiation-emitting components on two different partial surface regions and,
C) producing electrical contact-connections to the radiation-emitting components.

In this case, an order of the steps of the method is not prescribed by the abovementioned order of the method steps or by the designation of the steps, but rather can result for example from a technical realizability. In particular, steps of the method can be effected before or after other steps regardless of their designation, and it may furthermore also be possible that a plurality of steps can be effected simultaneously. Furthermore, method steps can comprise a plurality of substeps, wherein each substep, regardless of its designation, may be able to be performed before or after or at the same time as one or a plurality of substeps of the same or of one or a plurality of other method steps. In particular, the order of method steps and/or substeps of method steps can be different in different embodiments.

In one embodiment of the method, a spatial orientation of a partial surface region of the surface of the carrier body is defined by a normal vector. In this case, a normal vector may be able to be understood hereinafter particularly preferably as a bound vector whose origin lies in the associated partial surface region and which in this case is directed away from the carrier body in a manner situated perpendicular to the partial surface region. In this case, a partial surface region can be planar or curved, wherein a curved partial surface region can be for example a two-dimensionally or a three-dimensionally curved partial surface region. In particular, a curved partial surface region can also be defined by a normal vector, wherein it may be advantageous if the normal vector of a curved partial surface region is obtainable for example by averaging normal vectors which each

define partial regions of the partial surface region. In this case, the partial regions of the partial surface region can have a finite size or can be infinitesimally small. The normal vector of a curved surface can be provided in particular by the normal vector of a tangential plane applied to the partial region of the partial surface region. In this case, averaging can denote any customary and suitable averaging method. In particular, two normal vectors pointing in different spatial directions can be referred to as different.

Different partial surface regions on which radiation-emitting components are arranged can adjoin one another or can be separated from one another by further partial surface regions on which no radiation-emitting components are arranged.

One preferred embodiment of the method involves providing a carrier body having a high thermal conductivity. A high thermal conductivity may prove to be advantageous, for example, if a large amount of heat is generated for instance by the radiation-emitting components during operation and has to be dissipated from the radiation-emitting components for example for lasting and failure-free operation of the radiation-emitting components. A suitably high thermal conductivity may be made possible for example by a carrier body comprising one or a plurality of metals. Metals such as aluminum, copper or other metals or metal compounds or alloys shall be mentioned by way of example for this. It is also possible to use other materials such as, for instance, ceramics and/or plastics alone or in combination with the abovementioned metals when providing the carrier

body. The carrier body can furthermore have different partial regions composed of different materials, for example a core composed of a first material and an encapsulation of the core composed of one or a plurality of further materials. In this case, the encapsulation can be structured or unstructured. Providing the carrier body can comprise, in particular, the production of such a carrier body composed of one or a plurality of materials and/or material layers.

Furthermore, a carrier body can have for example at least one so-called heat pipe. A heat pipe advantageously enables heat to be dissipated effectively at least from partial regions of the carrier body. In this case, the at least one heat pipe can be integrated in the carrier body, for instance.

It may be advantageous, in particular, if a carrier body is provided which comprises copper, aluminum, or an alloy with at least one of copper and aluminum. It may be particularly advantageous if a carrier body is provided which is composed of aluminum or composed of copper.

By way of example, the carrier body can be formed as a flexible sheet, in particular composed of aluminum or copper, or is a flexible film, on which the at least two radiation-emitting components are applied on different partial surface regions, and the sheet or the film can be bent, such that the normal vectors of the abovementioned partial surface regions on which the radiation-emitting components are arranged point in different spatial directions. The bending of the sheet or the film can be carried out before or after the radiation-emitting components have been applied. By way of example, the manufacturing apparatuses such as automatic placement machines, etc. can work better with planar geometries. This circumstance is a factor in favor of carrying out the bending of the sheet or the film subsequently, after applying the radiation-emitting components and producing the electrical contact-connection to the radiation-emitting components. However, it may also be advantageous to carry out the bending of the sheet or the film after applying the radiation-emitting components and before producing the electrical contact-connection to the radiation-emitting components, in order for example to avoid the risk of damage to the contact-connection by the bending of the sheet or the film. Finally, however, it is also possible to carry out the bending of the sheet or the film before applying the radiation-emitting components and before carrying out the contact-connection to the radiation-emitting components.

One embodiment of the method involves providing a carrier body having a parallelepiped-like form. In this case, parallelepiped-like can mean that a carrier body is provided whose form is derived from a parallelepiped and has essential features of a parallelepiped, in particular that the carrier body has six side faces, opposite sides of which are congruent and are parallel and adjacent side faces of which lie in planes which form right angles with one another. In this case, in the case of a parallelepiped-like carrier body, for example edges can have bevels and/or rounded portions. Furthermore, side faces or partial surface regions can have structurings such as depressions or elevations, for instance. Preferably, a parallelepiped-like carrier body has an elongate form, that is to say that the parallelepiped-like carrier body can be longer along one principal axis than along the other two spatial axes. A carrier body having a prism-like form can be provided as an alternative. In this case, prism-like should be understood in a similar manner to parallelepiped-like, in particular such that for example a carrier body is provided which has a prism form with beveled and/or rounded edges and/or structurings such as, for instance, depressions or elevations on partial surface regions. In this case, a carrier body having a prism-like form can have a circular, elliptical, triangular or n-gonal cross-sectional area, where n is an integer greater than four, or a combination thereof. In this case, the cross-sectional area can preferably be a sectional area through the prism-like carrier body perpendicular to the prism axis. Preferably, a carrier body having an elongate prism-like form can be provided; that means that the prism axis of the prism-like carrier body can be longer than a diameter, a diagonal or a side of the base area.

In particular, partial surface regions of the carrier body can be side faces of a carrier body, in particular of a parallelepiped-like carrier body. As an alternative, partial surface regions can comprise partial regions of side faces of a carrier body or be partial regions of side faces.

In one embodiment of the method, at least one of the at least two radiation-emitting components which are arranged on the carrier body has a semiconductor light emitting diode (LED). Preferably, all of the at least two radiation-emitting components can have LEDs.

In particular, a component group, as a radiation-emitting component, can also have a functional arrangement having at least two LEDs or having at least two radiation-emitting components. In this case, an LED can denote a semiconductor layer sequence having suitable electrical contacts or an arrangement comprising a semiconductor layer sequence which is fitted in a housing which, for its part, has electrical contacts. In this case, a functional arrangement having at least two LEDs can furthermore comprise a base body, for example comprising a plastic or preferably a ceramic, on which the at least two LEDs are fitted and electrically connected. In this case, “electrically connected” can mean that the at least two LEDs of the functional arrangement are electrically conductively connected to one another in series, in parallel, or in a combination thereof. A functional arrangement having at least two LEDs preferably has, on a base body, electrical contact-connection possibilities for the electrical connection of the at least two LEDs, via which the electrically connected LEDs can be connected to a current and/or voltage supply.

The at least two radiation-emitting components can have identical or different emission spectra. In particular, the at least two LEDs of a functional arrangement can also have identical or different emission spectra. If the radiation-emitting components or the at least two LEDs of a functional arrangement have different emission spectra, then it is possible for example for an observer to be given a mixed-colored luminous impression by means of a suitable superposition of the emission spectra. An emission spectrum advantageously has one or a plurality of wavelengths or one or a plurality of ranges

of wavelengths from a range from ultraviolet to infrared electromagnetic radiation, in particular from blue to red light.

In one embodiment of the method, the at least two radiation-emitting components have inorganic semiconductor chips, thin-film semiconductor chips or organic semiconductor chips as LEDs. In particular, it can be advantageous to use thin-film semiconductor chips emitting in the blue or ultraviolet wavelength range, in particular GaN-based thin-film semiconductor chips, with a wavelength conversion substance disposed downstream in the beam path. In this case, the wavelength conversion substance can be selected in such a way that an LED has a white emission spectrum.

A thin-film light emitting diode chip can be distinguished in particular by the following characteristic features:
a reflective layer is applied or formed at a first main area—facing toward a carrier element—of a radiation-generating epitaxial layer sequence, said reflective layer reflecting at least part of the electromagnetic radiation generated in the epitaxial layer sequence back into the latter;
the epitaxial layer sequence has a thickness in the region of 20 μm or less, in particular in the region of 10 μm; and
the epitaxial layer sequence contains at least one semiconductor layer having at least one area which has an intermixing structure which ideally leads to an approximately ergodic distribution of the light in the epitaxial layer sequence, that is to say that it has an as far as possible ergodically stochastic scattering behavior.

A basic principle of a thin-film light emitting diode chip is described for example in I. Schnitzer et al., Appl. Phys. Lett. 63 (16), Oct. 18, 1993, 2174-2176, the disclosure content of which in this respect is hereby incorporated by reference.

A thin-film light emitting diode chip is to a good approximation a Lambertian surface emitter and may therefore be particularly well suited to application in a headlight.

In one embodiment of the method, the arrangement of the at least two radiation-emitting components on different partial surface regions of the carrier body comprises the following steps:

B1) applying an adhesion agent to the radiation-emitting components and/or to the partial surface regions of the carrier body,
B2) positioning the radiation-emitting components on the partial surface regions, and
B3) fixing the radiation-emitting components on the partial surface regions.

In this case, an adhesion agent can comprise an adhesive or a solder, for example. An adhesion agent preferably comprises a curable adhesive, preferably an adhesive based on silicone, epoxide, urethane, acrylate or cyanoacrylate. Particularly advantageously, a curable adhesive can comprise or be a thermally conductive silicone or epoxide adhesive. In this case, a curable adhesive can be cured by ultraviolet radiation, by heat, by application of force, by a chemical reaction, for example with moisture or air, or by some other suitable manner or a combination thereof. In this case, the curable adhesive can be cured completely in one step or be partly cured in each case in two or more partial steps, such that for example the totality of the partial steps brings about curing of the adhesive. In this case, the adhesive can be curved in each case in a different manner in different partial steps, for example by a low supply of heat in a first partial step and by a higher supply of heat in a second partial step or for example by ultraviolet radiation in a first partial step and by supply of heat in a second partial step. In particular, it may be advantageous for the adhesive to be precured in a first partial step, such that a radiation-emitting component is pre-fixed on a partial surface region. In this case, “pre-fixing” can mean that the radiation-emitting component adheres and remains on the partial surface region for an appropriate period of time, that is to say for example for a period of time of the order of magnitude of the duration of the production process for the radiation-emitting device. In one or a plurality of further partial steps, the adhesive can then be cured and bring about a permanent fixing of the radiation-emitting component on the partial surface region. In this case, a permanent fixing (“fixing”) can mean that the radiation-emitting component preferably adheres and remains permanently on the partial surface region even under mechanical loading, for example.

Furthermore, in one embodiment of the method, a first adhesion agent and a second adhesion agent can be applied to the radiation-emitting components and/or the partial surface regions. In this case, it may be advantageous if a rapidly curable adhesive is applied as first adhesion agent and a further curable adhesive or a solder is applied a second adhesion agent. In this case, a rapidly curable adhesive can be for example an adhesive which can be cured in less than a few seconds. It may be advantageous if a rapidly curable adhesive can be cured for example solely by a chemical reaction for example with moisture or air and/or by brief supply of heat. In this case, the first adhesion agent can be applied at one or more points, while the second adhesion agent can be applied in large-area fashion preferably on the entire contact area between a radiation-emitting component and a partial surface region or at least a large partial region thereof. Preferably, a permanent fixing of a radiation-emitting component on a partial surface region can be achieved by means of the second adhesion agent. In this case, it may be advantageous if the second adhesion agent comprises an adhesive which can be cured by supplying heat. A curable adhesive applied as second adhesion agent can have for example a curing time in the range of a plurality of seconds up to a plurality of minutes or longer. Consequently, as first adhesion agent it is possible to use an adhesive which cures more rapidly than the curable adhesive used as second adhesion agent.

In one embodiment of the method, at least two of the abovementioned method steps B1 to B3 are performed sequentially, that is to say simultaneously or directly successively for a radiation-emitting component. This can mean, in particular, that for example directly after applying at least one adhesion agent to a radiation-emitting component and/or a partial

surface region, the radiation-emitting component is positioned and fixed on the partial surface region before, after the application of at least one adhesion agent to a further radiation-emitting component and/or a further partial surface region, the further radiation-emitting component is arranged and fixed on the further surface partial region. In this case, a radiation-emitting component can be pre-fixed before it is fixed. As an alternative, by way of example, at least one adhesion agent can be applied to all of the radiation-emitting components and/or partial surface regions and the radiation-emitting components can furthermore be applied to the partial surface regions sequentially.

In a further embodiment of the method, at least one of the method steps B1 to B3 is performed in parallel, that is to say in each case simultaneously or directly successively for all the radiation-emitting components. Preferably, by way of example, the radiation-emitting components can be positioned and pre-fixed on the partial surface regions simultaneously or directly successively after applying at least one adhesive agent on the radiation-emitting components and/or the partial surface regions and can furthermore be fixed simultaneously after positioning and pre-fixing all the radiation-emitting components. By way of example, an economical and fast production method can be made possible by simultaneously fixing all the radiation-emitting components on the partial surface regions by simultaneously curing a curable adhesive.

A positioning of at least one of the at least two radiation-emitting components can be effected in an active or passive manner. A positioning in an active manner can be effected for example by a positioning with the aid of an active positioning system. Such an active positioning system can have for example a positioning element and a position monitoring element, wherein the positioning element can arrange a radiation-emitting component over and/or on a partial surface region, while the position of the radiation-emitting component can be monitored by the position monitoring element. By influencing the positioning element with regard to the position of the radiation-emitting component by means of the position monitoring element it may be possible to achieve a high accuracy with regard to the position of the radiation-emitting component. In this case, a positioning element can be a device which is movable in one or a plurality of spatial directions and which can take up, position and deposit a radiation-emitting component, for example a movable gripping arm. A position monitoring element can have optical and/or mechanical sensors, for example, with the aid of which the position of the radiation-emitting component can be detected metrologically. A position monitoring element can comprise for instance a camera, an optical distance meter, mechanical sensors or other suitable sensors. As an alternative, a positioning of a radiation-emitting component can be effected in a passive manner by means of a gauge, for example, which can have for example at least one fixing possibility for a radiation-emitting component. The gauge can assume a predefined position relative to the carrier body and/or at least the partial surface region of the carrier body on which the radiation-emitting component is intended to be positioned, such that a radiation-emitting component temporarily fixed in the gauge can be positioned on the partial surface region. A temporary fixing of a radiation-emitting component in the gauge can be effected for example by mechanical holding means, for instance clamps or holding clips.

In one embodiment of the method, a pre-fixing of at least one of the at least two radiation-emitting components on a partial surface region of the carrier body can be effected by mechanical holding means, for instance by clamps or holding clips. For this purpose, by way of example, the carrier body can have mechanical holding means, e.g. the clamps or holding clips already mentioned above. As an alternative or in addition, a pre-fixing can also be effected by a gauge which can remain for example until the permanent fixing of a radiation-emitting component at the carrier body.

In one embodiment of the method, the method step of producing electrical contact-connections to the radiation-emitting components comprises the following steps:

C1) applying electrical leads to the carrier body,
C2) producing electrically conductive connections between the electrical leads and the radiation-emitting components.

In this case, it may be advantageous if an electrically insulating matrix with electrical leads is provided, which is applied to the carrier body. The application of the electrically insulating matrix with the electrical leads can be effected by adhesive bonding or lamination, for example. In this case, the electrically insulating matrix can be flexible, for instance in the form of a flexible film or a flexible strip, or be rigid. In particular, it may be advantageous if a rigid electrically insulating matrix, before being applied to the carrier body, is preformed such that the rigid electrically insulating matrix is in contact with the carrier body at least to a substantial extent, advantageously entirely or at least almost entirely. An electrically insulating matrix can for example have openings in which the radiation-emitting components are arranged or can be arranged after the application of the electrically insulating matrix.

The electrical leads can be arranged on the electrically insulating matrix, such that the electrical leads are not covered by the electrically insulating matrix. As an alternative, the electrical leads can also be at least partly encapsulated by the electrically insulating matrix. Such an arrangement of the electrically insulating matrix and the electrical leads can have for example a protection of the electrical lead.

In a particularly advantageous embodiment, a, that is to say in particular a single, electrically insulating matrix with electrical leads for all the radiation-emitting components is applied on the carrier body. This can mean, in particular, that the electrically insulating matrix extends at least over some partial surface regions of the carrier body, in particular also partial surface regions

on which radiation-emitting components are arranged. In particular, the electrical leads can also extend over some partial surface regions of the carrier body, in particular also partial surface regions in which radiation-emitting components are arranged. It may be advantageous in this case if the electrically insulating matrix has suitable bending radii in regions of the carrier body which have edges.

In a further particularly preferred embodiment of the method, a polyimide strip with conductor tracks is provided as flexible electrically insulating matrix with electrical leads. In this case, a polyimide strip can be embodied as a polyimide film, for example. Polyimide as electrically insulating matrix can preferably have high temperature stability and a good mechanical strength in a wide temperature range. As an alternative, a flexible electrically insulating matrix can comprise other materials, for instance further plastics.

In a further embodiment of the method, the method step of producing electrical contact-connections to the radiation-emitting components comprises the following steps:

C1a′) providing electrical leads in the form of conductor tracks,
C1b′) arranging the electrical leads on the carrier body, and
C1c′) molding an electrically insulating matrix around the electrical leads and the carrier body.

The molding around process can be effected for example by means of suitable molding, casting or drawing methods. In this case, the electrically insulating

matrix can comprise for example an epoxy or acrylate-based resin. It may furthermore be advantageous if the electrical leads are arranged on the carrier body such that no electrically conductive contact arises between the electrical leads and the carrier body. By way of example, the electrical leads can be at least partly encapsulated with an electrically insulating material before being arranged on the carrier body. As an alternative or in addition, before the electrical leads are arranged on the carrier body, an electrically insulating material can be applied at least in partial regions of the carrier body. In this case, the electrically insulating material can be structured such that it has regions, for example depressions, for instance, in which the electrical leads can be arranged. In this case, the electrically insulating material can comprise the same material as or a different material than the electrically insulating matrix.

The electrically insulating matrix can be molded around the electrical leads at least in part, preferably in substantial part. As a result, it may be possible for a protection of the electrical leads and also a stability of the arrangement of the electrical leads to be achieved.

In a further embodiment of the method, method step A of providing the carrier body comprises the following steps:

A1) providing a carrier body,
A2) producing an electrically insulating layer at least on partial regions of the surface, and
A3) applying electrical leads to the insulating layer.

In this case, the partial regions of the surface can comprise the partial surface regions on which the at least two radiation-emitting components are arranged.

Producing an electrically insulating layer can be effected for example by applying an electrically insulating material to the carrier body. Such an electrically insulating material can be for example a plastic, for instance an epoxy- or acrylate-based resin.

Preferably, producing an electrically insulating layer at least on partial regions of the surface of the carrier body can be effected by provision with an electrically insulating oxide layer. In particular, the surface of a carrier body which has a surface composed of aluminum or which is preferably composed of aluminum can be oxidized at least in partial regions such that the surface has an electrically insulating oxide layer at least in the partial regions. In particular, it may be advantageous if the electrically insulating oxide layer is effected by anodizing the surface of the carrier body at least in partial regions.

In one embodiment of the method, the electrical leads are produced by means of a lithographic method on the electrically insulating layer, preferably an oxide layer, on the partial regions of the surface of the carrier body. A lithographic method can comprise the following steps, for example:
applying an electrically conductive layer to the electrically insulating layer,
applying a layer comprising a photoresist to the electrically conductive layer,
arranging a mask over a photoresist layer,
exposing the photoresist layer through the mask,
removing the non-exposed regions (negative photoresist layer), or the exposed regions (positive photoresist layer), of the photoresist layer, wherein a photoresist layer with structures is formed and
transferring the structure of the photoresist layer into the underlying electrically conductive layer, for example by means of an etching method.

By applying an electrically insulating layer on the electrical leads applied in this way, further electrical leads can be applied over the electrical leads by means of the same or a different method. The electrically conductive layer and/or the photoresist layer can be applied by vapor deposition or spin-coating techniques.

Furthermore, electrical leads as described further above can be arranged on the electrically insulating layer, preferably an oxide layer, for example in the form of conductor tracks and have an electrically insulating matrix molded around them. Furthermore, it may also be possible for electrical leads to be applied at least to partial regions of the surface of the carrier body by means of a printing technique with electrically conductive paste.

In one preferred embodiment of the method, electrical leads with electrical contact points are produced in one of the abovementioned steps of producing electrical leads. Electrical contact points can provide, in particular, a contact area via which an electrically conductive connection to a radiation-emitting component can be effected. In this case, by way of example,

electrical leads as far as the electrical contact points can be surrounded by an electrically insulating matrix in order to be able to ensure maximum protection of the electrical leads.

In a further embodiment of the method, producing the electrically conductive connection between electrical leads, in particular for example electrical contact points of electrical leads, and a radiation-emitting component is effected by means of at least one of the methods of bonding, soldering, for example laser soldering, and adhesive bonding. In this case, it may be advantageous to produce an electrically conductive connection by bonding if the radiation-emitting component has electrical contact-connection possibilities on a side remote from the carrier body. Soldering or adhesive bonding, particularly with an electrically conductive adhesive or an anisotropically electrically conductive adhesive, may be advantageous if the radiation-emitting component has electrical contact-connection possibilities on a side facing the carrier body. In particular, the radiation-emitting component can also be pre-fixed or fixed by producing an electrically conductive connection by soldering or adhesive bonding.

In a further embodiment of the method, method step B of arranging the at least two radiation-emitting components on different partial surface regions comprises the following steps:

B1) providing a polyimide strip with conductor tracks,
B2) arranging at least two radiation-emitting components on the polyimide strip with conductor tracks, and
B3) arranging the polyimide strip with conductor tracks and the radiation-emitting components arranged thereon on the carrier body, such that the polyimide strip is arranged on at least two different partial surface regions.

In this case, producing electrically conductive connections between the conductor tracks and the at least two radiation-emitting components can be effected before or after arranging the polyimide strip with conductor tracks and the radiation-emitting components arranged thereon on the carrier body.

The at least two radiation-emitting components can be fixed on the polyimide strip by an adhesion agent, for example, in particular by an adhesion agent comprising an adhesive or a solder. The polyimide strip with conductor tracks and the radiation-emitting components arranged thereon can be fixed for example by adhesive bonding or lamination on the carrier body.

In one embodiment of the method, the electrical leads are applied such that the at least two radiation-emitting components are connected in series, in parallel, or in a combination thereof, after producing an electrical connection between the electrical leads and the at least two radiation-emitting components. Furthermore, the electrical leads can have further active or passive electronic components. In particular, the electrical leads can have electrical contact-connection possibilities in order to be able to connect the electrical leads and, in particular, thereby the at least two radiation-emitting components to a current and/or voltage supply.

In one embodiment of a radiation-emitting device, the radiation-emitting device has a carrier body having a surface, wherein the surface has different partial surface regions and the normal vectors of the different partial surface regions point in different spatial directions. In this case, at least two radiation-emitting components can be arranged on two different partial surface regions. Furthermore, the radiation-emitting device can have electrical leads which can be arranged at least on the two different partial surface regions and can be electrically conductively connected to the at least two radiation-emitting components, wherein the at least two radiation-emitting components can be connected in series, in parallel, or in a combination thereof, by means of the electrical leads.

Furthermore, the electrical leads can have electrical contact points via which the radiation-emitting components can be connected to a current and/or voltage supply.

In one embodiment of a method for producing an illumination device comprising at least one radiation-emitting device, at least one radiation-emitting device and a reflector are arranged with respect to one another in such a way that the illumination device emits the radiation emitted by the radiation-emitting components of the at least one radiation-emitting device during the operation in an emission direction. This can mean, in particular, that a reflector is provided which is shaped such that the radiation emitted by the radiation-emitting components is superposed in such a way that an observer is given the impression of a homogeneous and/or uniform emission in the emission direction. In this case, “homogeneous and/or uniform” can denote a uniform color impression and/or a uniform intensity distribution of the radiation in the emission direction. By way of example, the reflector can be a rotationally symmetrical concave mirror, for instance in the form of a paraboloid of revolution, or a freeform surface reflector. In this case, a suitable reflector can have a plurality of reflector parts which form a contiguous reflective surface. Furthermore, a reflector can have reflector parts which are arranged in spatially separated fashion and therefore form a non-contiguous reflective surface.

In one embodiment of an illumination device, at least one radiation-emitting device and a reflector are arranged with respect to one another in such a way that the illumination device emits the radiation emitted by the radiation-emitting components during operation in an emission direction. In this case, the reflector can be shaped such that it at least partly surrounds the at least one radiation-emitting device. In this case, it may be advantageous if the at least one radiation-emitting device is mechanically connected to the reflector.

Further advantages and advantageous embodiments and developments of the invention will become apparent from the embodiments described below in conjunction with the figures.

In the figures:

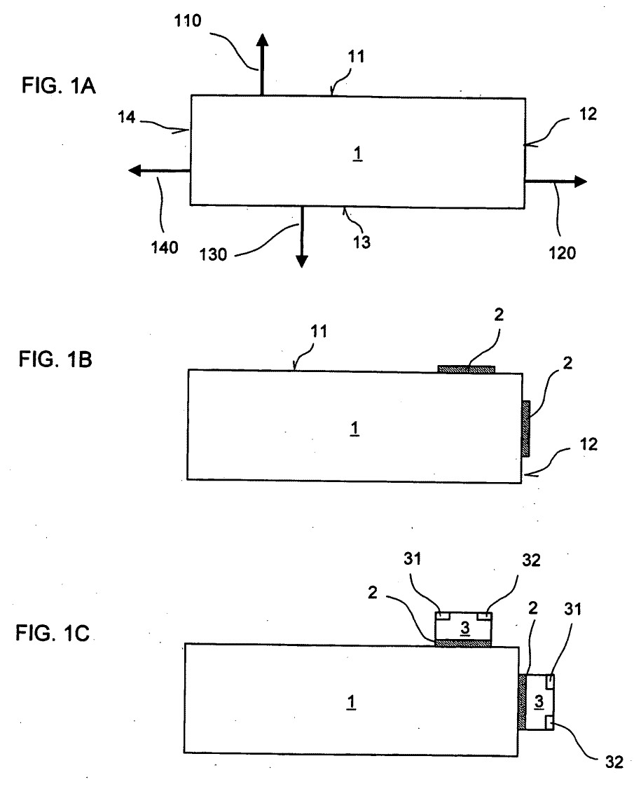

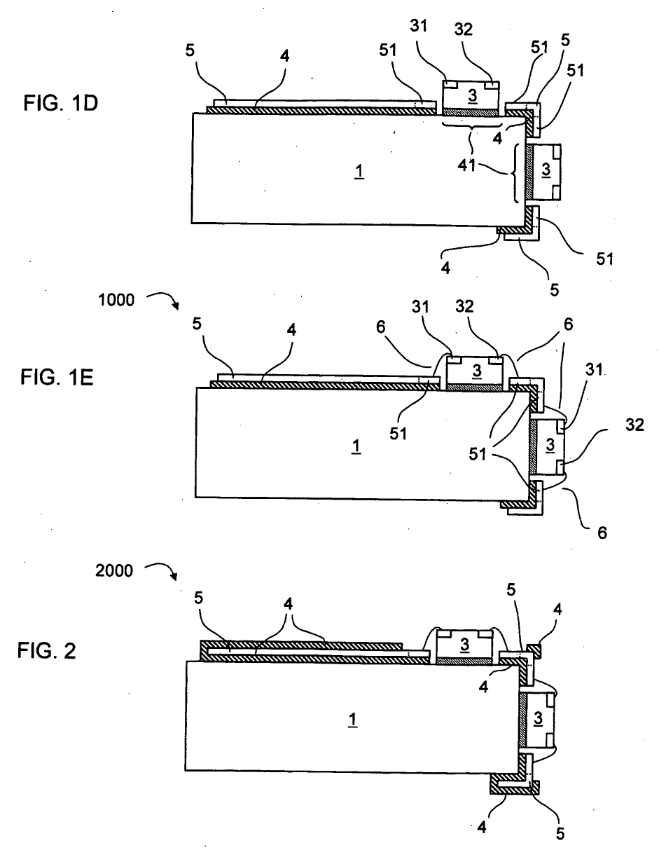

FIGS. 1A to 1E show schematic sectional illustrations of method steps in accordance with at least one exemplary embodiment,

FIG. 2 shows a schematic sectional illustration of a radiation-emitting device in accordance with at least one further exemplary embodiment,

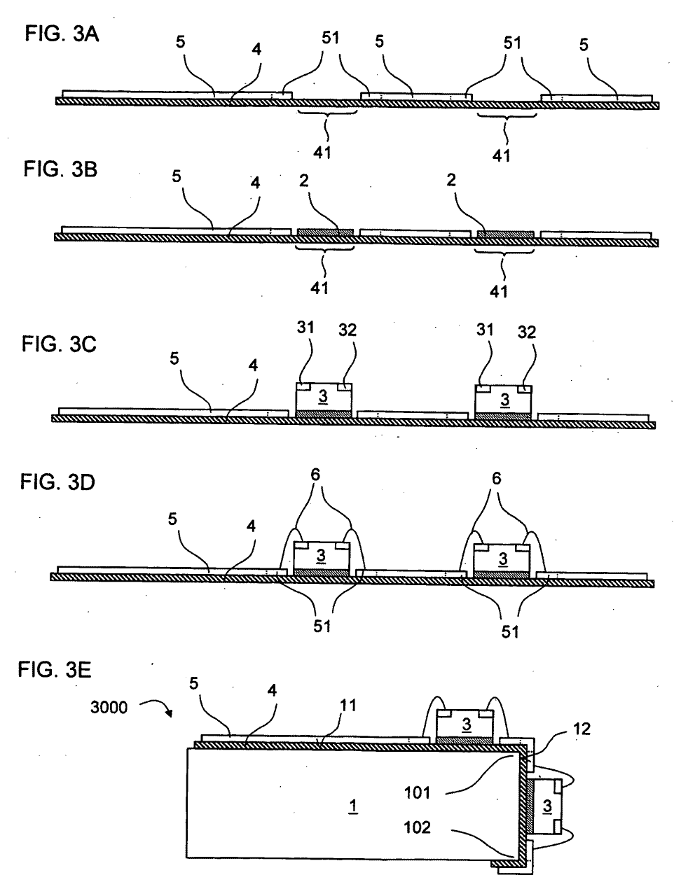

FIGS. 3A to 3E show schematic sectional illustrations of method steps in accordance with at least yet another exemplary embodiment,

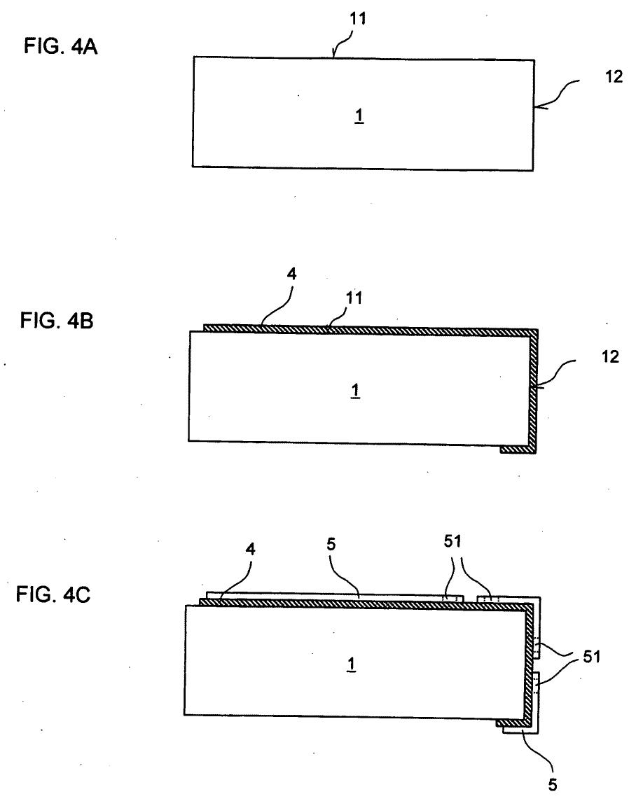

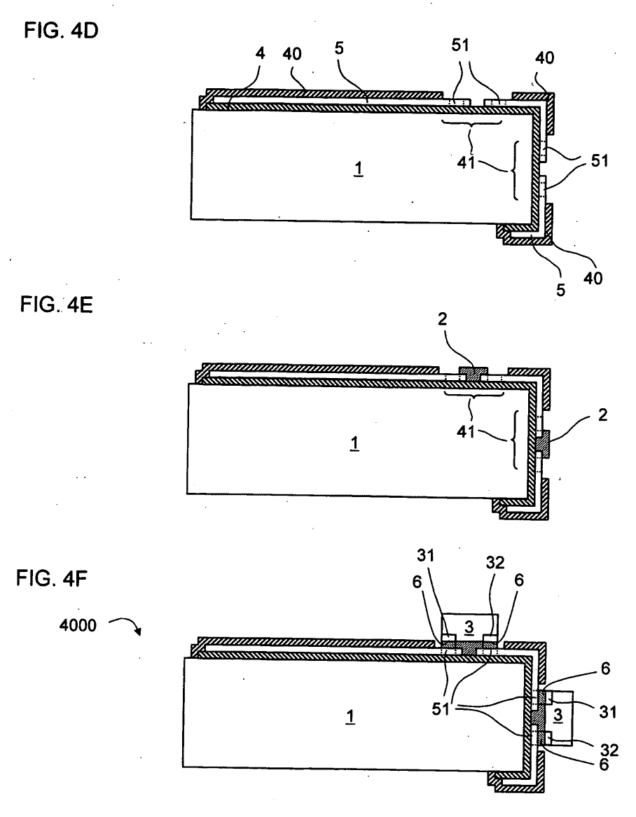

FIGS. 4A to 4F show schematic sectional illustrations of method steps in accordance with at least yet another exemplary embodiment,

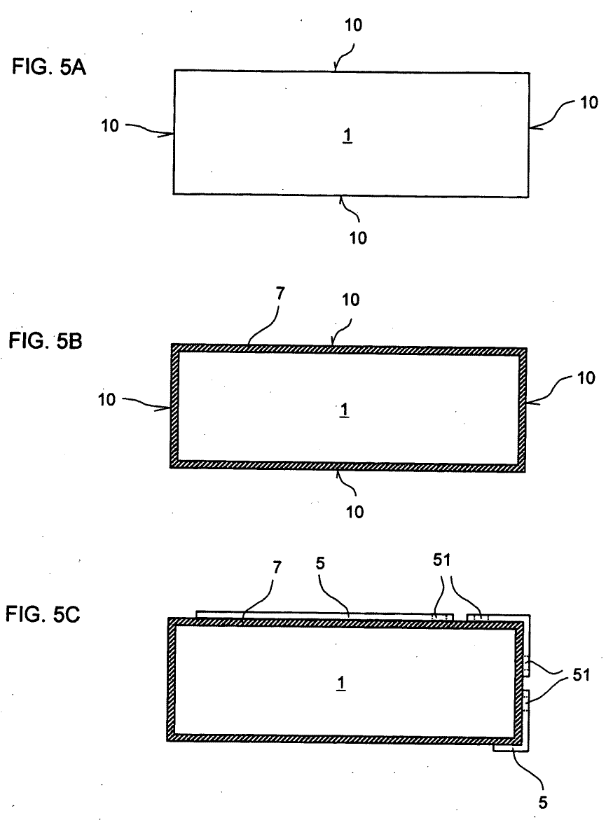

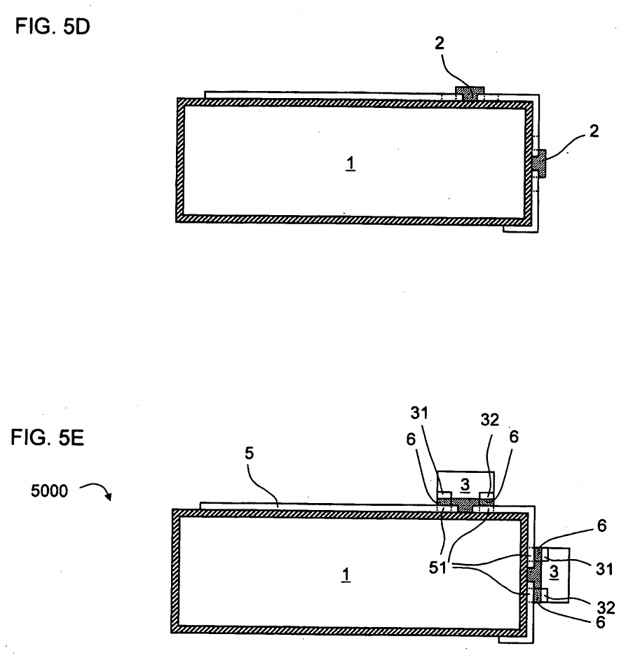

FIGS. 5A to 5E show schematic sectional illustrations of method steps in accordance with at least yet another exemplary embodiment, and

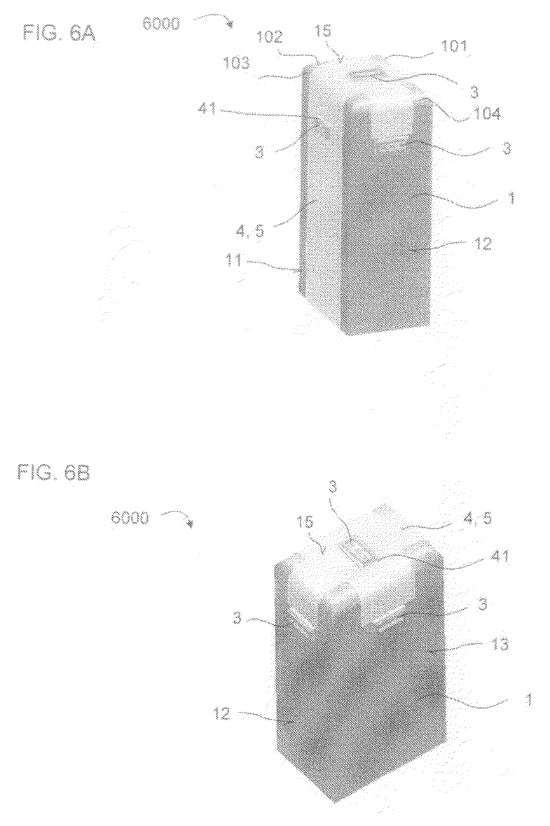

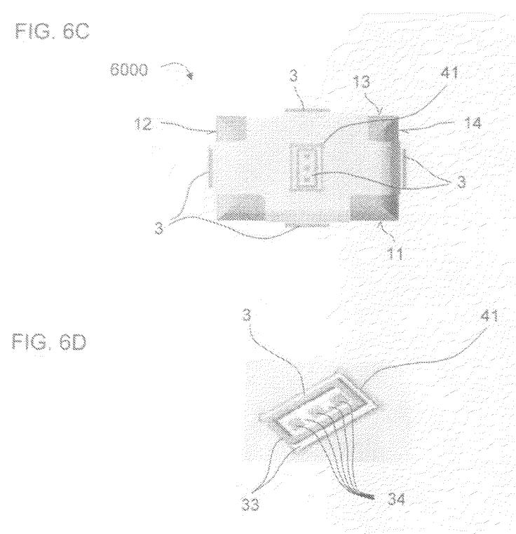

FIGS. 6A to 6D show schematic three-dimensional illustrations in accordance with at least one further exemplary embodiment.

Identical or identically acting constituent parts are in each case provided with the same reference symbols in the exemplary embodiments and figures. The elements illustrated and their size relationships among one another should not be regarded as true to scale, in principle, rather individual elements, such as e.g. layers, may be illustrated with an exaggerated thickness for the sake of better representability and/or for the sake of a better understanding.

FIGS. 1A to 1E describe a method for producing a radiation-emitting device 1000 in accordance with one exemplary embodiment.

In this case, FIG. 1A shows a carrier body 1 in a schematic sectional illustration, said carrier body being provided in a first method step. The carrier body 1 can be for example a parallelepiped or parallelepiped-like and have, inter alia, the partial surface regions 11, 12, 13, 14, which can correspond for example to side faces of the carrier body 1. With regard to its orientation spatially and relative to other partial surface regions, each of the partial surface regions 11, 12, 13, 14 can be described and defined in each case by a normal vector 110, 120, 130, 140. In this case, the normal vectors are perpendicular to the associated partial surface regions and point away from the carrier body. As an alternative, in the method step in accordance with FIG. 1A, it is also possible for example to provide a prism-shaped or a prism-like carrier body 1 for example having circular, elliptical, triangular or n-gonal (n can be an integer greater than four) faces 12 and 14. The partial surface regions 11 and 13 can then be for example side faces, parts of side faces or parts of the lateral surface of the prism-shaped or prism-like carrier body 1.

In a further method step in accordance with FIG. 1B, an adhesion agent 2 is applied to two partial surface regions 11 and 12. In this case, the adhesion agent 2, which can preferably comprise a curable adhesive, can preferably be applied on the partial surface regions 11 and 12 where radiation-emitting components are intended to be arranged. In this case, the application of the adhesion agent 2 to the two partial surface regions 11 and 12 should be understood purely by way of example and does not constitute any restriction with regard to the number of radiation-emitting components that can be applied. In particular, more than one radiation-emitting component can be arranged on a partial surface region. Furthermore, radiation-emitting components may also be able to be arranged

on other partial surface regions, for example on the partial surface regions 13 and/or 14, such that an adhesion agent 2 can likewise be applied on these other partial surface regions.

In a further method in accordance with FIG. 1C, radiation-emitting components 3 are positioned and arranged on the adhesion agent 2. After each of the radiation-emitting components 3 has been arranged, the adhesion agent can be precured in order to achieve a prefixing of the radiation-emitting components 3. Precuring can be effected by supplying heat, ultraviolet radiation or for example also by means of a contact pressure in the course of arranging the radiation-emitting components 3, or by a combination of the methods mentioned. After all the radiation-emitting components 3 have been arranged, the adhesion agent 2 can be cured in order to achieve a permanent fixing of the radiation-emitting components 3.

As an alternative, prior to arranging the radiation-emitting components 3, the adhesion agent 2 can be applied to the radiation-emitting components 3 instead of to the partial surface regions 11 and 12. The adhesion agent 2 can also be applied to the partial surface regions 11 and 12 and to the radiation-emitting components 3.

The adhesion agent 2 can also comprise two curable adhesives, of which the first curable adhesive can be cured very rapidly, preferably within a few seconds or faster, in order to achieve a pre-fixing of the radiation-emitting components 3 in each case after arrangement on the partial surface regions 11 and 12, respectively. The further curable adhesive of the adhesion agent 2 can ensure

a permanent fixing of the radiation-emitting components 3 on the carrier body 1 after curing. In this case, the adhesion agent 2 can comprise a mixture of the two curable adhesives, or as an alternative or in addition different regions comprising either the first curable adhesive or the second curable adhesive. As an alternative, the adhesion agent 2 can comprise a solder instead of a second curable adhesive or in addition thereto, which solder can ensure a permanent fixing of the radiation-emitting components 3 on the carrier body 1 in a reflow soldering process or some other suitable soldering process, for example. In particular, it is advantageous if the first adhesive can be cured more rapidly than the second curable adhesive.

A radiation-emitting component 3 can be for example at least one semiconductor light emitting diode (LED) or a component group having a functional arrangement having at least two LEDs can be used as radiation-emitting component 3. The one LED or the functional arrangement having at least two LEDs can preferably have electrical contacts 31, 32 via which an electrical contact-connection of the radiation-emitting component 3 can be effected

In a further method step in accordance with FIG. 1D, an electrically insulating matrix 4 with electrical leads 5 can be applied to the carrier body, in particular preferably to the partial surface regions 11 and 12, but also to further partial surface regions. In this case, the electrically insulating matrix 4 can be for example a plastic film, preferably for instance a polyimide film, on which electrical leads 5 are arranged. The use

of polyimide as material for the electrically insulating matrix may be advantageous on account of the high temperature stability and sufficient strength which can be afforded by a polyimide film. The electrically insulating matrix 4 can preferably have cutouts 41 in which the radiation-emitting components are arranged, such that the electrically insulating matrix 4 at least partly surrounds the radiation-emitting components 3. The electrically insulating matrix 4 with the electrical leads 5 can be adhesively bonded or laminated onto the carrier body, for example.

As an alternative to the order of the method steps as illustrated in FIGS. 1B to 1D, the method step in accordance with FIG. 1D, namely applying the electrically insulating matrix 4 with the electrical leads 5, can be performed before the method step in accordance with FIG. 1B, namely applying the adhesion agent 2, or before the method step in accordance with FIG. 1C, namely arranging and at least pre-fixing or else fixing the radiation-emitting components 3.

The electrical leads 5 can preferably have electrical contact points 51 close to the cutouts 41 and thus close to the radiation-emitting components 3. The electrical contact points can have for example a relatively large width, a relatively large area, or an elevation or some other structuring which is suitable for facilitating an electrical contact-connection. Furthermore, electrical contact points can have a layer sequence composed of different materials, preferably composed of different metals such as, for instance, nickel or gold or metal alloys. For instance, a layer sequence comprising at least one layer

composed of nickel and at least one layer composed of gold may be advantageous. An electrical contact-connection of a radiation-emitting component 3 can advantageously be facilitated by an arrangement of an electrical contact point 51 close to or else adjoining a cutout 41. Furthermore, it is also possible for the electrical leads 5 to have no specially structured contact points 51 and nevertheless for an electrical contact-connection to be produced between the leads 5 and the radiation-emitting components 3.

In a further method step in accordance with FIG. 1E, electrical contact-connections are produced between electrical contact points 51 of the electrical leads 5 and electrical contacts of the radiation-emitting components 3 by fitting bonding wires 6. The electrical leads 5 are structured on the electrically insulating matrix preferably such that the radiation-emitting components 3 electrically contact-connected in this way can be connected in series, in parallel, or—in the case of an arrangement of at least three radiation-emitting components 3—in a combination thereof. As an alternative to an electrical contact-connection with bonding wires 6, an electrical contact-connection by means of soldering or welding can also be effected. Furthermore, an electrical contact-connection can also be effected by adhesive bonding with an electrically conductive adhesive.

The radiation-emitting device 1000 that can be produced by the method steps in accordance with FIGS. 1A to 1E thus has at least two radiation-emitting components 3 which can emit radiation in different spatial directions on account of their arrangement on partial surface regions 11, 12 of the carrier body 1. By virtue of the electrical contact-connection of the radiation-emitting components 3 via

electrical leads which can be arranged on an electrically insulating matrix 4 directly on the carrier body 1, the radiation-emitting device 1000 can thus have a very compact and robust design.

In addition to the electrical contact points 51 for the electrical contact-connection of the radiation-emitting components 3, the electrical leads can also have electrical contact points or electrical contact-connection possibilities (not shown) for connecting the radiation-emitting device 1000 to a current and/or voltage supply.

FIG. 2 shows a further exemplary embodiment of a radiation-emitting device 2000, which can be produced for example by means of the method steps of the exemplary embodiment shown in FIGS. 1A to 1E. In this case, the radiation-emitting device 2000 has an electrically insulating matrix 4 which at least partly surrounds the electrical leads 5. In particular, it may be advantageous in this case if only the electrical contact points 51 on one side are not surrounded by the electrically insulating matrix 4, in particular on that side of the electrical contact points 51 which is remote from the carrier body. By way of example, the electrically insulating matrix can be a polyimide film or a polyimide strip which at least partly encapsulates electrical leads 5, for instance conductor tracks. The electrical leads 5 can be encapsulated with the electrically insulating matrix in a lamination process, for example. The encapsulation of the electrical leads 5 can thus ensure a protection of the electrical leads, for instance, which can reduce for example

the risk of damage or a short circuit of electrical leads 5 by external effects.

FIGS. 3A to 3E show a further exemplary embodiment of a method for producing a radiation-emitting device 3000.

A first step of the method in accordance with FIG. 3A involves providing an electrically insulating matrix 4 with electrical leads 5. This can preferably be a polyimide film or a polyimide strip with structured conductor tracks having electrical contact points 51 as described further above for the radiation-emitting device 1000 or 2000. In particular, the electrically insulating matrix 4 and the electrical leads 5 can be structured for example such that in regions 41 on the electrically insulating matrix 4 in a further method step in accordance with FIG. 3B adhesion agent 2 can be applied in the regions 41. The adhesion agent can be for example an adhesion agent 2 comprising one curable adhesive or two curable adhesives as described further above in conjunction with the method steps for producing the radiation-emitting device 1000.

In further method steps in accordance with FIG. 3C and FIG. 3D, radiation-emitting components 3 can be arranged, pre-fixed and fixed and also electrically contact-connected on the electrically insulating matrix 4. As an alternative, fixing the radiation-emitting components 3 and/or electrical contact-connection can also be effected at a later point in time. Thus, in a further method step in accordance with FIG. 3E, a carrier body 1 can be provided

before or after the fixing and before or after the electrical contact-connection of the radiation-emitting components 3. The electrically insulating matrix 4 with the electrical leads 5 and the at least pre-fixed radiation-emitting components 3 can be arranged in such a way on the carrier body 1 provided that the radiation-emitting components 3 are simultaneously arranged on the partial surface regions 11, 12. In this case, the electrically insulating matrix 4 can be adhesively bonded or laminated onto the carrier body 1, for example. The use of a flexible film or a flexible strip as electrically insulating matrix 4 can therefore enable the electrically insulating matrix 4 to be easily arranged on the carrier body. In this case, it may be advantageous if the electrically insulating matrix 4 and/or the electrical leads 5; in regions where the carrier body has corners or edges 101, 102, for example, have corresponding bending radii in order for example to avoid a delamination of the electrically insulating matrix 4 and the electrical leads 5. Furthermore, it may be advantageous if the carrier body itself has corners or edges 101, 102 which are rounded, wherein bending radii of the electrically insulating matrix 4 and/or of the electrical leads 5 can be adapted to the radii of the rounded corners or edges.

FIGS. 4A to 4F show a further exemplary embodiment of a method for producing a radiation-emitting device 4000.

A first method step in accordance with FIG. 4A involves providing a carrier body 1. In this case, the carrier body can for example have an electrically conductive surface

or be composed of an electrically conductive material. In particular, the carrier 1 can comprise aluminum or copper or be composed of aluminum or copper.

In a further method step in accordance with FIG. 4B, an electrically insulating material 4 can be applied at least to partial surface regions 11, 12. In this case, the electrically insulating material 4 can be for example a plastic, for instance a plastic film, which can be adhesively bonded or laminated at least onto the partial surface regions 11, 12, or preferably a resin, for example based on epoxide or acrylate, which can be used to mould around the carrier body 1 at least in part.

In a further method in accordance with FIG. 4C, electrical leads 5 having electrical contact points 51 can be arranged on the electrically insulating material 4. Electrical leads can be structured conductor tracks, for example.

In a further method step in accordance with FIG. 4D, a further electrically insulating material 40 can be molded around the electrical leads 5, wherein preferably an identical or similar electrically insulating material 40 to the electrically insulating material 4 can be used.

As an alternative, electrical leads 5 can be provided which already have molded around them or are encapsulated by, at least in part, an electrically insulating matrix 4 or an electrically insulating material 4. By way of example, such electrical leads 5 can be at least partly encapsulated with an electrically insulating material 4

in a lamination process or a molding process. The method step in accordance with FIG. 4D can be obviated in this case. The electrical leads 5 at least partly encapsulated with an electrically insulating material 4 can have molded around them or be encapsulated by, at least in part, a similar, identical or other electrically insulating material 40 in the method step in accordance with FIG. 4D.

In a further method step in accordance with FIG. 4E, an adhesion agent 2 can be applied in regions 41 which can preferably be free of electrically insulating material 4 and 40. Radiation-emitting components 3 can be pre-fixed by the adhesion agent, which can preferably comprise a rapidly curing adhesive, which components can be arranged in the regions 41 in a further method step in accordance with FIG. 4F. By way of example, the electrical leads 5 with the electrical contact points 51 can be structured such that an electrical contact-connection between electrical contacts 31, 32 of the radiation-emitting components 3 and electrical contact points 51 can be effected by a soldering process by means of a solder 6. As an alternative, an electrically conductive adhesive 6 can be used instead of a solder 6. Preferably, all the radiation-emitting components 3 are arranged and pre-fixed on the carrier body in the regions 41 before an electrical contact-connection and permanent fixing of the radiation-emitting components 3 are effected by means of the soldering process, for example a reflow soldering process. As an alternative to an adhesion agent 2 and a solder 6 or an electrically conductive adhesive 6, it is also possible to use an electrically anisotropically conductive adhesive, for example.

FIGS. 5A to 5E show a further exemplary embodiment of a method for producing a radiation-emitting device 5000.

A first method step in accordance with FIG. 5A involves providing a carrier body which has a surface 10 composed of aluminum or is preferably composed of aluminum. By means of an oxidation in a further method step in accordance with FIG. 5B, the surface 10 can be converted into an electrically insulating oxide, preferably an aluminum oxide. In this case, an oxide layer can advantageously be produced by anodizing the surface 10 of the carrier body 1. The oxide layer can be produced for example on the entire surface 10 of the carrier body 1 or only on partial surface regions on which electrical leads or electrical leads and radiation-emitting components are intended to be fitted.

In a further method step in accordance with FIG. 5C it is possible to arrange electrical leads 5 with electrical contact points 51. In this case, the arrangement of electrical leads 5 can be effected as in the method steps in accordance with FIGS. 4C and 4D. As an alternative, electrical leads 5 can preferably be arranged by means of a lithography process, as described in the general part of the description.

In further method steps in accordance with FIGS. 5D and 5E, radiation-emitting components 3 can furthermore be arranged on the electrical leads 5. These method steps can be effected for example like the method steps in accordance with FIGS. 4E and 4F.

A radiation-emitting device 5000, preferably having an oxide or anodized layer 7 and electrical leads arranged thereon by means of a lithography process, may be distinguished by a compact construction, for example.

FIGS. 6A to 6D show a further exemplary embodiment of a radiation-emitting device 6000. In this case, the radiation-emitting device 6000 has a parallelepiped-like carrier body 1 having a parallelepipedal form and rounded edges 101, 102, 103, 104. In particular, the carrier body 1 in the exemplary embodiment shown can have a height of approximately (75+/−0.05) mm, a length of approximately (30+/−0.05) mm and a width of approximately (20+/−0.05) mm. Furthermore, the carrier body has partial surface regions 11, 12, 13, 14, 15 that are partial regions of side faces of the parallelepiped-like carrier body 1. At least on parts of the partial surface regions 11, 12, 13, 14, 15, an electrically insulating matrix 4 with electrical leads 5 is arranged on the carrier body 1 by means of one or more suitable method steps in accordance with the exemplary embodiments shown above. By means of the rounded edges 101, 102, 103, 104, the bending radii of the electrically insulating matrix 4 with the electrical leads 5 can be increased to an extent such that the probability of a delamination of the electrically insulating matrix 4 from the electrical leads 5 and/or the carrier body 1 and/or the probability of other damage to the electrically insulating matrix 4 and/or the electrical leads 5 can be prevented or reduced. In the exemplary embodiment shown, the electrically insulating matrix 4 with the electrical leads 5 can be a polyimide film or a polyimide strip with conductor tracks.

Radiation-emitting components 3 are arranged on the partial surface regions 11, 12, 13, 14, 15. For this purpose, the electrically insulating matrix 4 can furthermore have cutouts 41 on the partial surface regions 11 and 15, for example, in which cutouts radiation-emitting components 3 can be arranged. In the exemplary embodiment shown, the cutouts 41 can have a length of approximately 8 to 9 mm and a width of approximately 4.5 to 5.5 mm. Furthermore, the radiation-emitting components 3 in the exemplary embodiment shown have a functional arrangement of five LEDs 34 each arranged on a ceramic base body 33 (see detail excerpt in FIG. 6D). In this case, the ceramic base body 33 of a radiation-emitting component 3 can be fixed on the carrier body 1 preferably by means of an adhesion agent comprising at least one curable adhesive preferably comprising a thermally conductive silicone or epoxide adhesive. By virtue of the arrangement of the radiation-emitting components 3 directly on the carrier body 1, a low heat transfer resistance between the radiation-emitting components 3 and the carrier body 1 can be made possible and a cooling of the radiation-emitting components 3 can thus be achieved with the carrier body 1 as a heat sink. For this purpose, the carrier body 1 preferably comprises a metal, in particular aluminum or copper. By means of an electrical interconnection of the five LEDs 34, by providing two electrical contacts (not shown) an electrical contact-connection of the functional arrangement of the LEDs 34 with electrical leads 5 can be made possible (not shown). In the exemplary embodiment shown, the LEDs 34 can preferably be GaN-based thin-film semiconductor chips which can have a wavelength conversion substance

disposed downstream in the beam path and can therefore emit white light.

In a further exemplary embodiment (not illustrated by a figure), an illumination device can be producible by virtue of the fact that for example a reflector can be arranged with respect to the radiation-emitting device 6000 such that the radiation emitted by the radiation-emitting components 3 arranged on the partial surface regions 11, 12, 13, 14 is reflected in the emission direction of the radiation-emitting component arranged on the partial surface region 15. In this case, through a suitable choice of the reflector, a homogeneous and uniform and, particularly when using different-colored radiation-emitting components 3 and/or different-colored LEDs 34, mixed-colored luminous impression of the illumination device, and in particular an also uniform intensity distribution of the emitted radiation, can arise for an observer looking at the partial surface region 15. In particular a reflector can advantageously be mechanically connected to the radiation-emitting device 6000. For this purpose, the radiation-emitting device can have mechanical fastening possibilities, for example, for instance screwthreads for screw joints on a side face of the carrier body 1, for example on the side face opposite the partial surface region 15.

The invention is not restricted to the exemplary embodiments by the description on the basis of said exemplary embodiments. Rather, the invention encompasses any new feature and also any combination of features, which in particular comprises any combination of features in the patent claims, even if this feature or

this combination itself is not explicitly specified in the patent claims or exemplary embodiments.

1. A method for producing a radiation-emitting device comprising the steps of:
A) providing a carrier body (1) with a surface (10) having different partial surface regions (11, 12), wherein the normal vectors (110, 120) of the different partial surface regions (11, 12) point in different spatial directions,
B) arranging at least two radiation-emitting components (3) on two different partial surface regions (11, 12) and,
C) producing electrical contact-connections to the radiation-emitting components (3).

2. The method as claimed in claim 1, wherein method step A involves providing a carrier body (1) having a high thermal conductivity.

3. The method as claimed in claim 1, wherein method step A involves providing a carrier body (1) which can be produced from one or a plurality of metals.

4. The method as claimed in claim 1, wherein method step A involves providing a carrier body (1) comprising copper and/or aluminum.

5. The method as claimed in claim 1, wherein method step A involves providing a carrier body (1) having a parallelepiped-like form, a prism-like form, a cone-like form or a combination thereof.

6. The method as claimed in claim 5, wherein method step A involves providing a carrier body (1) having a parallelepiped-like form, and wherein the different partial surface regions (11, 12) correspond to different side faces of the parallelepiped.

7. The method as claimed in claim 1, wherein method step A involves providing a carrier body (1) composed of a flexible sheet or a flexible film, and the sheet or the film is bent in order to produce the different surface regions (11, 12) having normal vectors (110, 120) pointing in different spatial directions.

8. The method as claimed in claim 7, wherein the bending of the sheet or the film is performed after at least one of method steps B) or C) has been carried out.

9. The method as claimed in claim 7, wherein the bending of the sheet or the film is performed after method steps B) and C) have been carried out.

10. The method as claimed in claim 7, wherein the bending of the sheet or the film is performed before method steps B) and C) have been carried out.

11. The method as claimed in claim 1, wherein method step B involves arranging a component group (3) as radiation-emitting component to a partial surface region, wherein the component group (3) has a functional arrangement composed of at least two radiation-emitting components.

12. The method as claimed in claim 1, wherein radiation-emitting components (3) or component groups (3) are used which comprise at least one semiconductor light emitting diode (34) or a functional arrangement composed of at least two semiconductor light emitting diodes (34).

13. The method as claimed in claim 1, wherein the method step B comprises the following method steps:
B1) applying an adhesion agent (2) to the radiation-emitting components (3) and/or to the partial surface regions (11, 12),
B2) positioning the radiation-emitting components (3) on the partial surface regions (11, 12), and
B3) fixing the radiation-emitting components (3) on the partial surface regions (11, 12).

14. The method as claimed in claim 13, wherein method step B1 involves applying an adhesion agent (2) comprising an adhesive or a solder.

15. The method as claimed in claim 14, wherein method step B1 involves applying an adhesion agent (2) comprising a curable adhesive.

16. The method as claimed in claim 15, wherein method step B3 comprises the following method steps:
B3a) pre-fixing the radiation-emitting components (3) on the partial surface regions (11, 12) by precuring the curable adhesive,
B3b) finally fixing the radiation-emitting components (3) on the partial surface region (11, 12) by curing the curable adhesive.

17. The method as claimed in any of claims 13 to 16, wherein method step B1 comprises the following method steps:
B1a) applying a first adhesion agent to the radiation-emitting components (3) and/or to the partial surface regions (11, 12) and
B2b) applying a second adhesion agent to the radiation-emitting components (3) and/or to the partial surface regions (11, 12).

18. The method as claimed in claim 17, wherein
a rapidly curable adhesive is applied as first adhesion agent in method step B1a, and
a curable adhesive or a solder is applied as second adhesion agent in method step B2a.

19. The method as claimed in claim 13, wherein at least one of methods steps B1 to B3 is performed simultaneously or directly successively for all the radiation-emitting components (3).

20. The method as claimed in claim 19, wherein each of method steps B1 to B3 is in each case performed simultaneously or directly successively for all the radiation-emitting components (3).

21. The method as claimed in claim 13, wherein method steps B1 to B3 are performed directly successively for each of the radiating-emitting components (3).

22. The method as claimed in claim 13, wherein positioning the radiation-emitting components (3) in method step B2) is effected with the aid of an active positioning system or with the aid of a gauge.

23. The method as claimed in either of claims 14 or 15, wherein the radiation-emitting components are pre-fixed on the partial surface regions (11, 12) by mechanical holding means.

24. The method as claimed in claim 23, wherein a carrier body (1) with mechanical holding means is made available in method step A.

25. The method as claimed in claim 1, wherein method step C comprises the following method steps:
C1) applying electrical leads (5) to the carrier body (1),
C2) producing electrically conductive connections between the electrical leads (5) and the radiation-emitting components (3).

26. The method as claimed in claim 25, wherein method step C1 comprises the following steps:
C1a) providing an electrically insulating matrix (4) with electrical leads (5), and
C1b) applying the insulating matrix (4) with the electrical leads (5) to the carrier body (1).

27. The method as claimed in claim 26, wherein method step C2a involves adhesively bonding or laminating the electrically insulating matrix (4) with the electrical leads (5) onto the carrier body (1).

28. The method as claimed in claim 26 or 27, wherein
a single electrically insulating matrix (4) with the electrical leads (5) is provided for all the radiation-emitting components (3) in method step C1a, and
the electrically insulating matrix (4) with electrical leads (5) is applied to a plurality of partial surface regions (11, 12) in method step C1b.

29. The method as claimed in claim 26, wherein a polyimide strip with conductor tracks is provided as electrically insulating matrix (4) with the electrical leads (5).

30. The method as claimed in claim 25, wherein method step C1 comprises the following steps:
C1a′) providing electrical leads (5) in the form of conductor tracks,
C1b′) arranging the electrical leads (5) on the carrier body, and
C1c′) molding an electrically insulating matrix (4) around the electrical leads (5) and the carrier body (1).

31. The method as claimed in claim 1, wherein method step A comprises the following steps:
A1) providing a carrier body (1),
A2) producing a layer composed of an electrically insulating material (7) at least on partial regions of the surface (10), and
A3) producing electrical leads (5) on the electrically insulating material (7).

32. The method as claimed in claim 31, wherein the carrier body (1) is composed of aluminum and producing the layer composed of an electrically insulating material (7) is effected by oxidizing the aluminum.

33. The method as claimed in claim 32, wherein producing the layer composed of an electrically insulating material (7) is effected by anodizing the aluminum.

34. The method as claimed in any of claims 31 to 33, wherein method step A3 comprises producing electrical leads (5) by a lithographic method.

35. The method as claimed in claim 31, wherein
method step A3 comprises producing electrical leads (5) with electrical contact points (51), and
method step C comprises producing electrically conductive connections between the electrical contact points (51) of the electrical leads (5) and the radiation-emitting components (3).

36. The method as claimed in claim 25, wherein
method step C1 comprises applying electrical leads (5) with electrical contact points (51), and
method step C2 comprises producing electrically conductive connections between the electrical contact points (51) of the electrical leads (5) and the radiation-emitting components (3).

37. The method as claimed in claim 25, wherein producing the electrically conductive connection is effected by at least one of bonding, soldering, welding and adhesive bonding.

38. The method as claimed in claim 1, wherein
method step B comprises the following method steps:
B1) providing a polyimide strip (4) with conductor tracks (5),
B2) arranging at least two radiation-emitting components (3) on the polyimide strip (4) with conductor tracks (5), and
B3) arranging the polyimide strip (4) with conductor tracks (5) and the radiation-emitting components (3) arranged thereon on the carrier body (1), such that the polyimide strip (4) and the radiation-emitting components (3) are arranged on at least two different partial surface regions (11, 12), and
method step C can be effected before or after method step B3.

39. The method as claimed in claim 1, wherein the electrical leads (5) are fitted such that the radiation-emitting components (3) are connected in series, in parallel, or in a combination thereof, after method steps A, B and C have been performed.

40. A method for producing an illumination device comprising at least one radiation-emitting device (6000) produced as claimed in claim 1, wherein at least one radiation-emitting device (6000) and a reflector are arranged with respect to one another in such a way that the illumination device emits the radiation emitted by the radiation-emitting components (3) during operation in an emission direction.

41. A radiation-emitting device, comprising:
a carrier body (1) with a surface (10) having different partial surface regions (11, 12), wherein the normal vectors (110, 120) of the different partial surface regions (11, 12) point in different spatial directions,
at least two radiation-emitting components (3) arranged on two different partial surface regions (11, 12), and
electrical leads (5) wherein
the electrical leads (5) are arranged at least partly D the two different partial surface regions (11, 12),
the electrical leads (5) are electrically conductively connected to the radiation-emitting components (3), and
the radiation-emitting components (3) are connected in series, in parallel, or in a combination thereof, by the electrical leads (5).

42. An illumination device comprising a radiation-emitting device as claimed in claim 41 and a reflector, wherein the radiation-emitting device and the reflector are arranged with respect to one another in such a way that the illumination device emits the radiation emitted by the radiation-emitting components (3) during operation in an emission direction.
